(19) United States
(12) Patent Application Publication
(10) Pub. No.: US 2004/0019967 A1
(43) Pub. Date: Feb. 5, 2004

(54) Assistance apparatus for assisting a person into and out of bed

(76) Inventor: Dwane C. Gant, Corona, CA (US)

Correspondence Address: RICHARD E. BEE, P.O. BOX 10544, COSTA MESA, CA, 92627, US

(21) Appl. No.: 10/210,349

(22) Filed: Aug. 1, 2002

(51) Int. Cl. A61G 7/10; A61G 7/14

(52) U.S. Cl. 5/81.1 R; 5/86.1

(57) ABSTRACT

Assistance apparatus is provided for assisting a person into and out of bed. Such apparatus includes a chassis for positioning beside a bed and a torso support structure pivotally mounted on the chassis for supporting the torso of the person needing assistance. The torso support structure enables the person to move from a vertical position to a horizontal position as the torso support structure pivots from a vertical to a horizontal position, and vice versa. The assistance apparatus also includes a person support seat located on the chassis and an actuator mechanism for causing the seat to tilt to an inclined position for assisting the person to move to a standing position.

### BACKGROUND OF THE INVENTION

This invention relates to assistance apparatus for helping ill, infirm, injured, disabled and handicapped people perform everyday type physical activities.

It is sometimes difficult for infirm and disabled people to perform the everyday task of getting into and out of bed. Sometimes they cannot do it alone and require the assistance of another person. Sometimes another person is not available when the need arises. Or sometimes the other person is not strong enough to perform the task or to perform it in an entirely adequate manner. There is, therefore, a need for an assistance apparatus for enabling the infirm or disabled person to get himself or herself into or out of bed with a minimum of physical exertion and without the help of another person. Such apparatus should be of a reasonably convenient size and should be suitable for either hospital or home use.

### SUMMARY OF THE INVENTION

The present invention provides assistance apparatus for assisting a person into and out of bed. Such assistance apparatus comprises a chassis for positioning beside a bed. Such assistance apparatus also includes a torso support structure pivotally mounted on the chassis. Such assistance apparatus further includes an actuator mechanism mounted on the chassis and coupled to the torso support structure for causing the torso support structure to pivot from a vertical position to a horizontal position and vice versa. The torso support structure serves to support the torso of a person needing assistance and enables the person to move from a vertical position to a horizontal position as the torso support structure pivots from a vertical position to a horizontal position. The torso support structure also enables the person to move from a horizontal position to a vertical position as the torso support structure pivots from a horizontal position to a vertical position.

For a better understanding of the present invention, together with other and further advantages and features thereof, reference is made to the following description taken in connection with the accompanying drawings, the scope of the invention being pointed out in the appended claims.

### BRIEF DESCRIPTION OF THE DRAWINGS

Referring to the drawings:

FIG. 1 is an elevational view of assistance apparatus constructed in accordance with the present invention and showing a person sitting on the assistance apparatus in an upright position;

FIG. 2 is an elevational view of the FIG. 1 assistance apparatus showing the person and the person support portion of the apparatus in a partially inclined position;

FIG. 3 is an elevational view of the FIG. 1 assistance apparatus showing the person and the person support portion of the apparatus in a completely reclined or horizontal position;

FIG. 4 is a plan view of the assistance apparatus of FIG. 1 showing the assistance apparatus positioned on a right side of a bed;

FIG. 5 is a plan view of the assistance apparatus of FIG. 1 showing the assistance apparatus positioned on a left side of a bed;

FIG. 6 is an elevational view of a chassis portion of the FIG. 1 assistance apparatus;

FIG. 7 is a plan view of the chassis of FIG. 6;

FIG. 8 is a cross-sectional view of the FIG. 6 chassis taken along section line 8-8 of FIG. 6;

FIG. 9 is a perspective view of the assistance apparatus of FIG. 1 with the chassis side cover panels removed and showing the person support portion of the apparatus in an upright or vertical position.

FIG. 10 is a perspective view of the assistance apparatus as shown in FIG. 2 with the chassis side cover panels removed and showing the person support portion of the apparatus in a partially inclined position;

FIG. 11 is a perspective view of the assistance apparatus as shown in FIG. 3 with the chassis side cover panels removed and showing the person support portion of the apparatus in a horizontal position;

FIG. 12 is an elevational view of an arm structure portion of the FIG. 9 assistance apparatus;

FIG. 13 is a side view of the arm structure of FIG. 12;

FIG. 14 is an end view of the arm structure of FIG. 12;

FIG. 15 is an elevational view of a torso support assembly portion of the FIG. 9 assistance apparatus;

FIG. 16 is a plan view of the torso support assembly of FIG. 15;

FIG. 17 is a side view of a human support seat portion of the FIG. 9 assistance apparatus showing the human support seat tilted to an inclined position; and

FIG. 18 is a back view of a seat engaging mechanism used for raising the seat portion of FIG. 17.

### DETAILED DESCRIPTION OF THE ILLUSTRATED EMBODIMENT

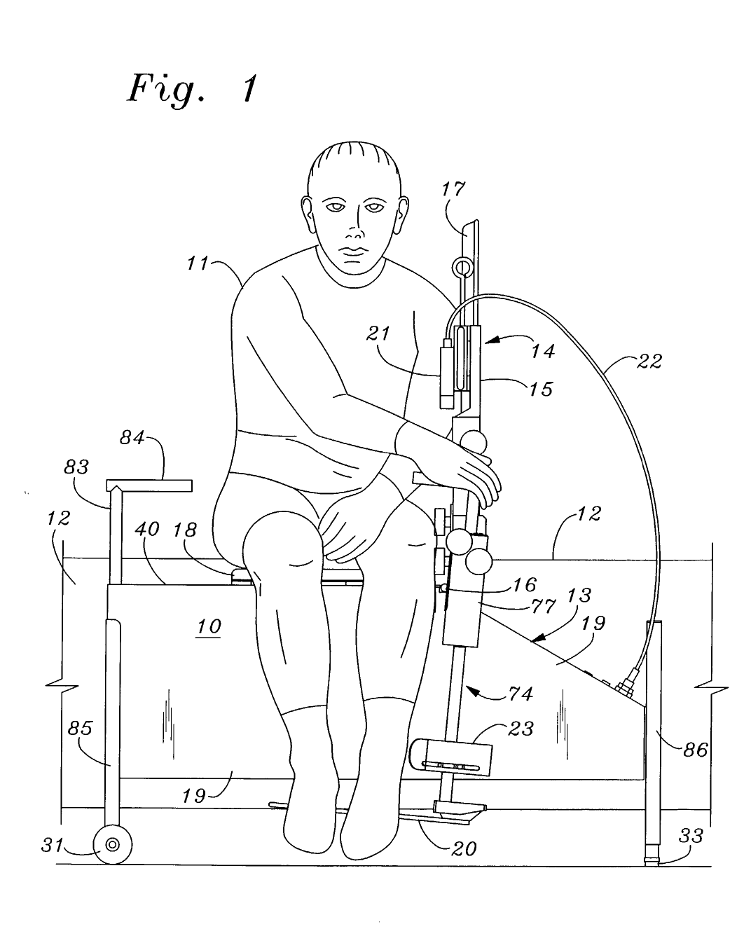

Referring to FIG. 1, there is shown assistance apparatus 10 constructed in accordance with a representative embodiment of the present invention for assisting a person 11 into and out of a bed 12. Such assistance apparatus 10 includes a chassis 13 for positioning along side of the bed 12. Apparatus 10 further includes a torso support structure 14 pivotally mounted on the chassis 13. This torso support structure 14 includes an arm structure 15 having upper and lower ends and an intermediate point 16 pivotally connected to the chassis 13. Torso support structure 14 also includes a torso support assembly 17 attached to an upper portion of the arm structure 15 for supporting the torso of the person 11 using the assistance apparatus 10.

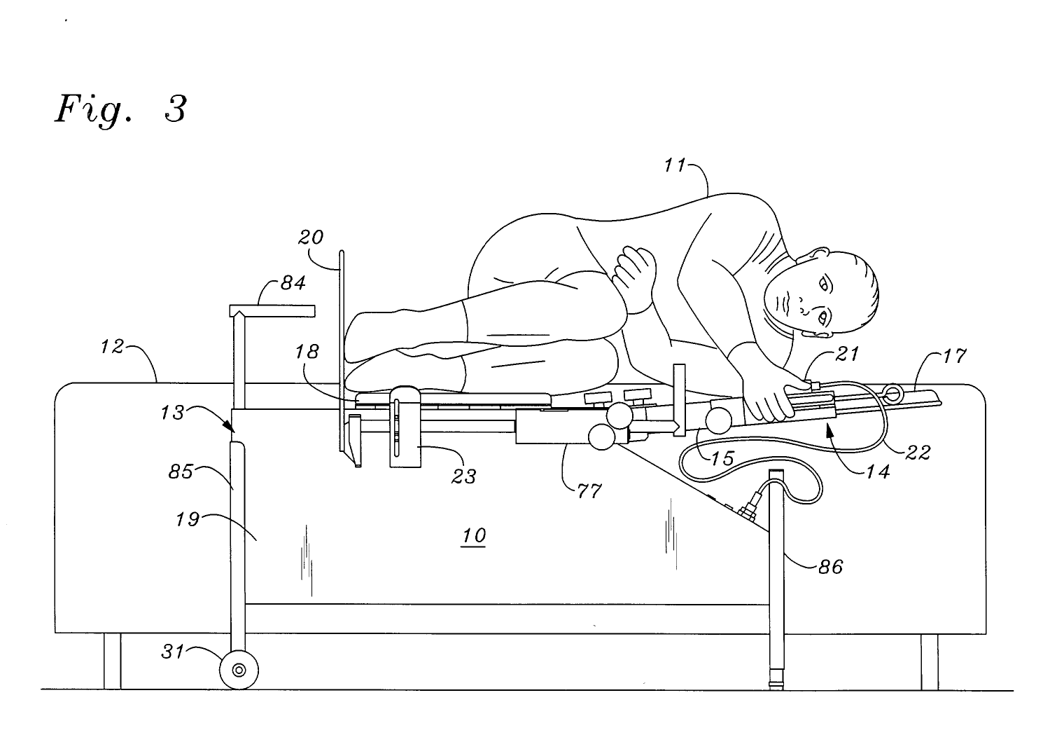

The assistance apparatus 10 includes an actuator mechanism (not visible in FIG. 1) mounted on the chassis 13 and coupled to the torso support structure 14 for causing the torso support structure 14 to pivot from a vertical position, as shown in FIG. 1, to a horizontal position, as shown in FIG. 3, and vice versa. As will be seen, this actuator mechanism is coupled to the lower end of arm structure 15 at a point below the arm structure pivot point 16.

The assistance apparatus 10 further includes a human support seat 18 located on an upper portion of the chassis 13. The person 11 is shown sitting on this seat 18 in FIG. 1. A second actuator mechanism (not visible in FIG. 1) is mounted on the chassis 13 and coupled to the bottom side of seat 18 for causing, when activated, seat 18 to tilt to an inclined position for assisting a person sitting on seat 18 to move to a standing position.

Removable cover panels 19 are provided on the front and back sides of chassis 13 for giving the assistance apparatus 10 a pleasing appearance and for protecting the actuator mechanisms located within chassis 13.

FIG. 1 shows a person 11 sitting in an upright position on seat 18. His feet are resting on a foot rest assembly 20 which is coupled to arm structure 15 for movement therewith. Located within chassis 13 are electrical control circuits for controlling activation and deactivation of the actuator mechanisms for the torso support arm structure 15 and the seat tilting mechanism for seat 18. Control switches for these actuator control circuits are located on a control pad 21 which is fastened to the an upper portion of arm structure 15 within easy reach of the person 11 sitting on seat 18. These control switches are coupled in circuit with the actuator control circuits by means of a multiconductor electrical cable 22. For safety purposes, the voltages applied to cable 22 are low voltages on the order of, for example, ten volts. Separate control switches and control circuits are provided for the two actuator mechanisms so that either actuator mechanism may be activated independently of the other.

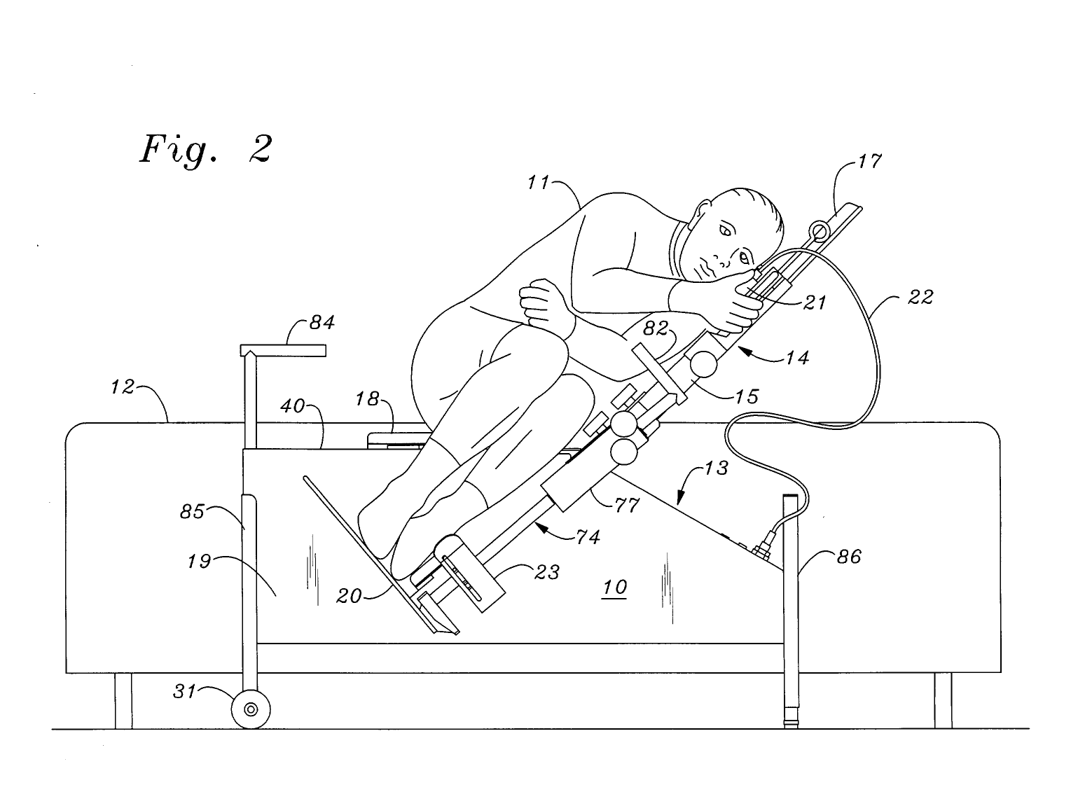

While sitting on the assistance apparatus 10 in the manner shown in FIG. 1, the person 11 may activate the “Down” control switch on control pad 21 to cause arm structure 15 to commence to pivot from the “up” or vertical position shown in FIG. 1 to the “down” or horizontal position shown in FIG. 3. FIG. 2 shows an intermediate or partially inclined position for the arm structure 15 and person 11. As the arm structure 15 pivots, a leg support assembly 23 coupled to the arm structure 15 engages and raises the nearer leg of person 11. This also raises the other leg which is resting on the nearer leg.

When the arm structure 15 reaches the “down” or horizontal position shown in FIG. 3, activation of its actuator mechanism is discontinued. This can be accomplished by person 11 releasing or switching off the “Down” switch on control pad 21. Preferably, a limit switch is also provided on chassis 13 for automatically deactivating the actuator mechanism when the full horizontal position is reached.

With the arm structure 15 in the horizontal position shown in FIG. 3, the person 11 may roll over onto the adjacent bed 12. Thereafter, when person 11 wants to get out of bed, a reverse procedure is followed. Person 11 rolls over onto the torso support structure 14 and activates an “Up” control switch on control pad 21. Arm structure 15 then pivots back to the upright or vertical position shown in FIG. 1. A second limit switch may be provided for automatically deactivating the arm actuator mechanism when the full vertical position is reached. When in the vertical position, person 11 may activate the seat tilting mechanism for seat 18 by activating a seat tilt “Up” control switch on control pad 21. This causes the rear end of seat 18 to raise to an elevated position and causes the seat 18 to tilt in the forward direction. This raises person 11 to a partially standing position from which person 11 may more easily move himself to a fully standing position.

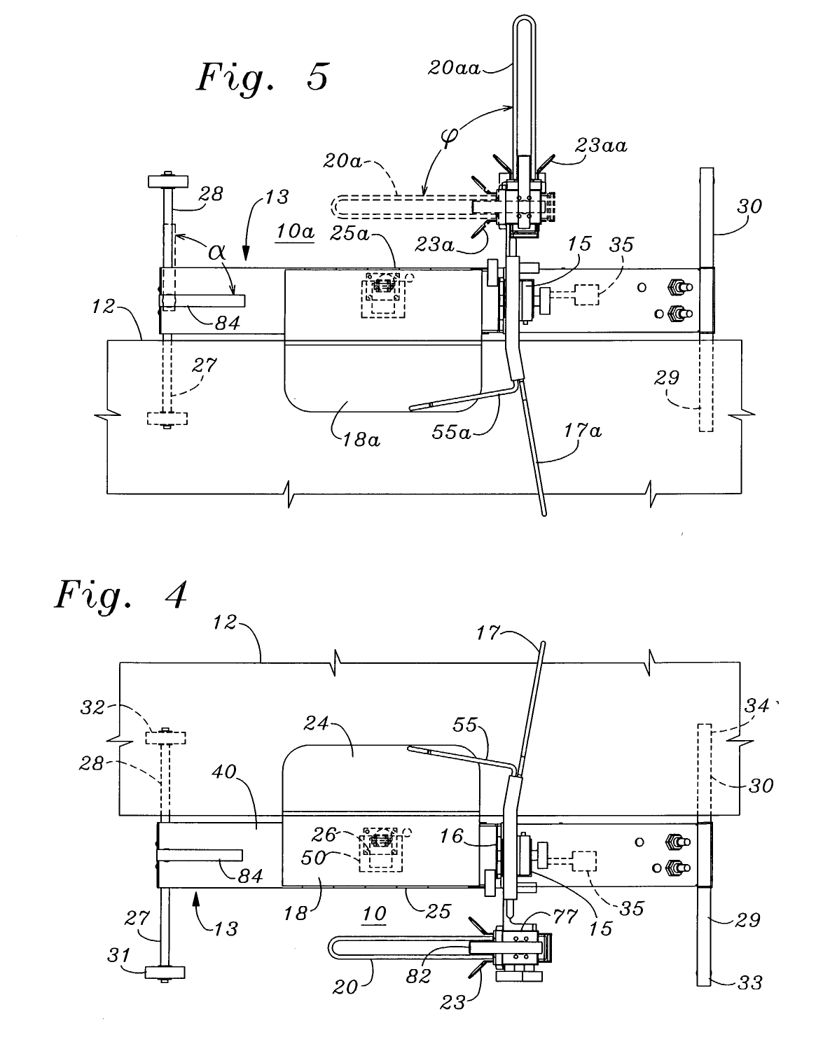

FIG. 4 shows a plan view of the assistance apparatus 10 positioned along the right side of bed 12 in position for use by person 11. Chassis 13 is positioned parallel to and immediately adjacent the side of the bed 12. A rearward portion 24 of seat 18 extends over and rests on top of bed 12. A front end 25 of seat 18 is hinge connected to the chassis 13 and a seat tilting actuator mechanism is indicated in phantom line form at 26. This actuator mechanism 26 is located in the lower part of chassis 13 below the seat 18.

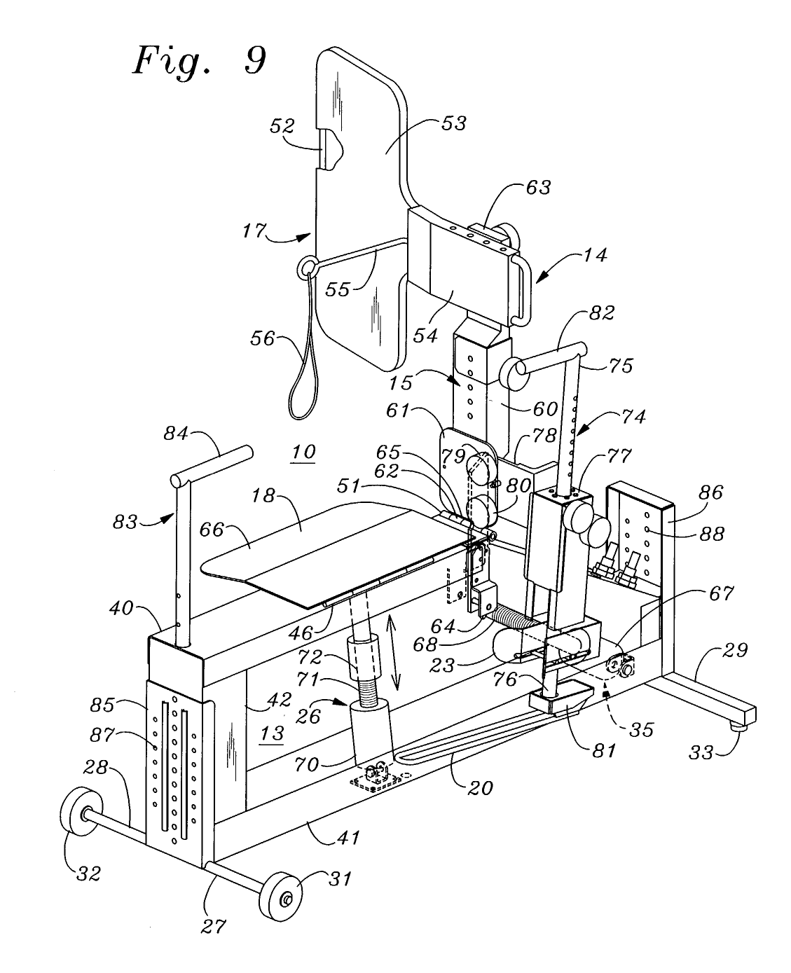

Laterally extending chassis support legs 27-30 are connected to the lower ends of chassis 13. The support legs 27 and 28 on the left in FIG. 4 are provided with rollers or wheels 31 and 32. The support legs 29 and 30 on the right are provided with fixed support pads 33 and 34 (see FIG. 9). The support legs 28 and 30 on the bedside of chassis 13 are positioned under the bed 12. The actuator mechanism for causing the arm structure 15 to pivot between vertical and horizontal positions is indicated in phantom line form at 35. This arm structure actuator mechanism 35 is located in the lower part of chassis 13 to the right of arm structure 15.

FIG. 5 is a plan view similar to FIG. 4 but showing the assistance apparatus positioned on the opposite or left side of bed 12. In this case, certain elements need to be repositioned on chassis 13. The reference numbers for the repositioned elements are the same as before but with the suffix letter “a” added. As a first matter, seat 18 is repositioned to 18a in FIG. 5. This is accomplished by reversing seat 18 and hinge connecting the front end 25a to the opposite side of chassis 13. The torso support assembly 17 also needs to be repositioned to 17a so as to extend out over the bed 12 which is now on the opposite side of chassis 13. This is accomplished by unfastening the torso support assembly 17 from the arm structure 15 and remounting it extending the other way as indicated at 17a. The foot rest assembly 20 and the leg support assembly 23 also need to be repositioned to the opposite side of chassis 13 to the positions indicated at 20a and 23a This is accomplished by unbolting a support member for these elements and repositioning such support member on the other side of chassis 13.

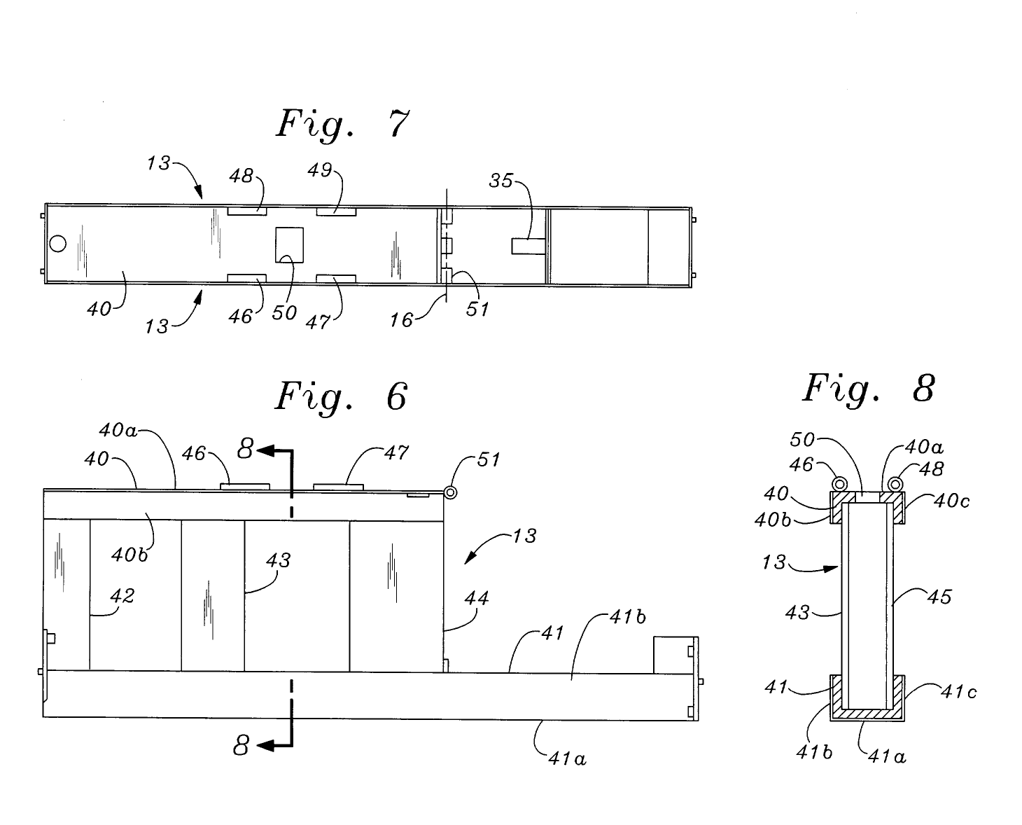

FIG. 6 is an elevational view of chassis 13 by itself and with the chassis side cover panels 19 removed. FIG. 7 is a plan view of the structure of FIG. 6 and FIG. 8 is a cross-sectional view taken along section line 8-8 of FIG. 6. As seen in these FIGURES, chassis 13 includes a horizontally-extending upper chassis member 40 for positioning parallel to the side of the bed 12 near the upper level of bed 12. As seen in FIG. 8, upper member 40 is an up-side-down U-shaped channel beam having a top portion 40a and downwardly extending side portions 40b and 40c. Chassis 13 further includes a horizontally extending lower chassis member 41 which extends the length of chassis 13, As seen in FIG. 8, lower member 41 is a U-shaped channel beam having a bottom portion 41a and upwardly extending side portions 41b and 41c. A plurality of vertically extending support struts 42-44 are fastened between side portions 40b and 41b of the upper and lower horizontal members 40 and 41. A second plurality of vertically extending support struts are connected between the rearward side portions 40c and 41c of the upper and lower horizontal members 40 and 41. The middle such strut is seen at 45 in FIG. 8.

A first set of hinge loops 46 and 47 are mounted along the forward edge of the upper horizontal beam 40 for hinge connecting the forward end 25 of seat 18 to the upper beam 40 for providing the configuration of FIG. 4. In use, these hinge loops 46 and 47 are pinned to a mating set of hinge loops on the forward end 25 of seat 18. A second set of hinge loops 48 and 49 are mounted along the rearward edge of upper beam 40 for use in providing the configuration of FIG. 5. In this case, seat 18 is turned around to position 18a and the hinge loops on forward end 25a are pinned to hinge loops 48 and 49.

An opening or passageway 50 is cut through the top portion 40a of upper horizontal beam 40 midway between the left hinge loops 46 and 48 and the right hinge loops 47 and 49. This passageway 50 enables connection of the seat-tilting mechanism to the underside of seat 18.

A further set of hinge loops 51 are provided across the right-hand end of upper beam 40. These hinge loops 51 are used for pivotally connecting the torso arm structure 15 to the chassis 13. The center line through these hinge loops 51 defines the pivot axis 16 for the arm structure 15. A drive motor for the actuator mechanism for arm structure 15 is indicated at 35.

FIG. 9 is a perspective view of the assistance apparatus 10 of FIG. 1 with the chassis cover panels 19 removed and the torso support structure 14 in an upright or vertical position. Also, some of the chassis vertical support struts (e.g., 43 and 44) of FIG. 6 have been omitted in FIG. 9 to better show the interior structures within chassis 13. Among other things, FIG. 9 shows in greater detail the construction of the torso support assembly 17 of FIG. 1. As indicated in FIG. 9, torso support assembly 17 includes a rectangular metal frame member 52 which is covered with a pliable fabric material 53 for supporting a major portion of the torso of the person 11 using the assistance apparatus 10. Torso support assembly 17 also includes a frame mounting assembly 54 for attaching the frame member 52 to the upper portion of arm structure 15. A strap hanger 55 extends outwardly from mounting assembly 54 at right angles to the plane of the frame member 52. A pull-up strap 56 is attached to the far end of strap hanger 55. This pull-up strap 56 may be used by the person 11 to pull himself onto the torso support assembly 17 during the process of getting out of bed.

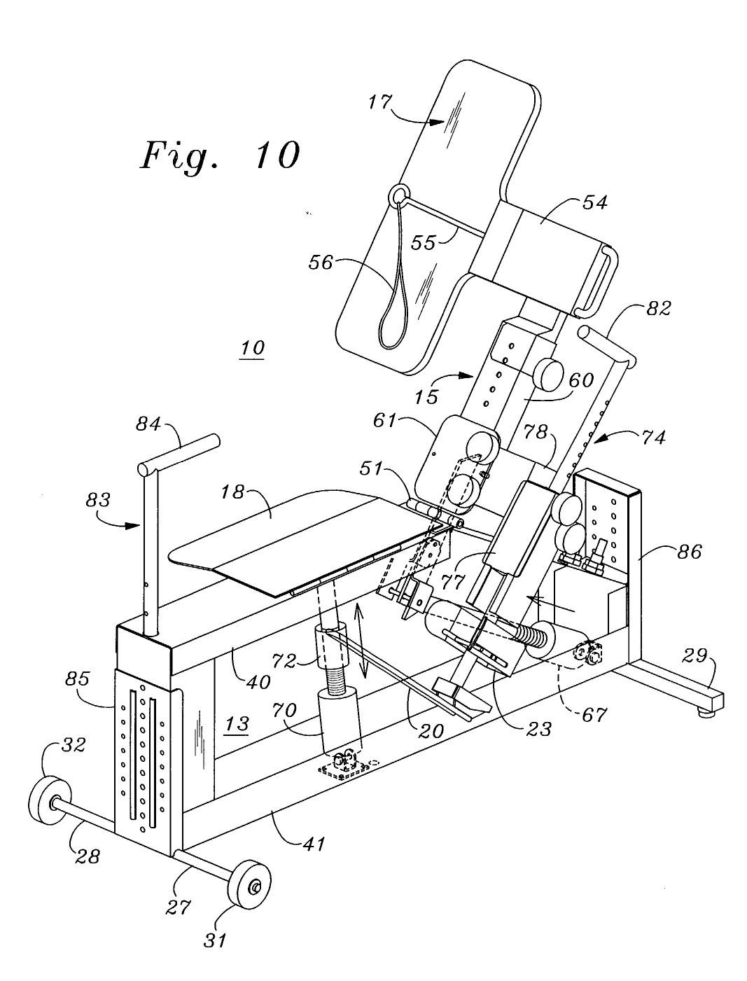

FIGS. 10 and 11 are perspective views similar to FIG. 9, with FIG. 10 showing the arm structure 15 in a partially inclined position and FIG. 11 showing the arm structure 15 in a horizontal position. The strap hanger 55 is pivotally mounted on the mounting assembly 54 and is shown in it's second position in FIG. 11. Arm structure 15 includes an elongated arm member 60 having an attachment plate 61 welded on the left-facing side thereof. Hinge loops 62 are provided on the lower end of attachment plate 61 for mating with hinge loops 51 on the right end of the upper horizontal chassis member 40. A pivot pin passes through and is mounted in the hinge loops 51 and 62 to enable the pivoting of the arm structure 15 with respect to the common center axis through hinge loops 51 and 62. Thus, arm structure 15 has an upper end 63, a lower end 64 and an intermediate point 65 (16 in FIG. 1) pivotally connected to the upper chassis member 40 near the right side of seat 18.

The torso support assembly 17 is attached to the upper portion of arm structure 15 and extends laterally toward the bed 12 (FIGS. 1-3) for supporting the torso of a person 11 and enabling him to move from a vertical position (FIG. 1) to a horizontal position (FIG. 3) as the arm structure 15 pivots from a vertical position (FIG. 9) to a horizontal position (FIG. 11). This helps person 11 to get into bed by the less strenuous action of rolling from the torso support assembly 17 onto the bed 12.

A reverse procedure is followed when the person wants to get out of bed. The arm structure 15 is placed in the horizontal position (FIG. 11). The person rolls over onto the torso support assembly 17 (FIG. 3). The arm structure 15 is pivoted from the horizontal position (FIG. 11) to the vertical position (FIG. 9) and the person is raised from the from the horizontal position (FIG. 3) to a vertical position (FIG. 1). As will be seen, seat 18 has a seat-tilting mechanism for raising the rear end 66 of seat 18. The tilting of seat 18 assists the person 11 to move to a standing position.

A first actuator mechanism 35 is coupled to the lower end 64 of the arm structure 15 for causing the arm structure 15 to pivot from a vertical position to a horizontal position and vice versa. This actuator mechanism includes a reversible electric motor 67 mounted inside the lower beam 41 of chassis 13. Electric motor 67 is connected to and, when activated, causes rotation of a threaded lead screw 68. Lead screw 68 is threaded through a movable nut assembly which is connected to the lower end 64 of arm structure 15. Thus, rotation of lead screw 68 causes movement of the nut assembly which, in turn, causes movement of the lower end 64 of arm structure 15. Depending on the direction of rotation of the motor 67, the lower end 64 of arm structure 15 is caused to move toward either the vertical position of FIG. 9 or the horizontal position of FIG. 11.

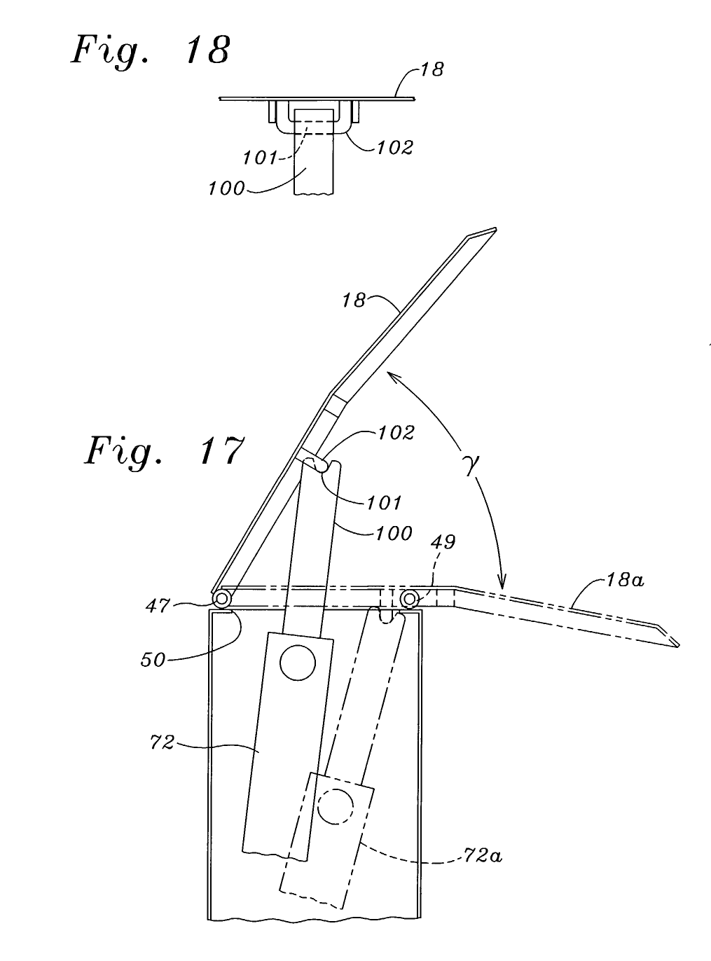

A second actuator mechanism 26 is mounted on the chassis 13 below the upper horizontal chassis member 40. This actuator mechanism 26 extends upwardly and is coupled to the underside of seat 18 for causing seat 18 to tilt to an inclined position (see FIG. 17) for assisting a person sitting on seat 18 to move to a standing position. Second actuator mechanism 26 includes a reversible electric motor 70 mounted inside the lower beam 41 of chassis 13. Electric motor 70 is connected to and, when activated, causes rotation of an upwardly extending threaded lead screw 71. Lead screw 71 is threaded into a movable nut assembly 72 which extends upwardly through passageway 50 in the upper horizontal beam 40 and engages the underside of seat 18. Rotation of lead screw 71 causes vertical movement of nut assembly 72 which, in turn, causes the rearward side 66 of seat 18 to move up or down, the forward edge of seat 18 being hinge connected to the upper horizontal beam 40 by hinge loops 46 and 47.

As previously mentioned, energizing of arm structure motor 67 and seat tilting motor 70 are controlled by control switches located on the control pad 21 shown in FIG. 1.

As best seen in FIGS. 9-11, the assistance apparatus 10 further includes an elongated support member 74 which is coupled to the arm structure 15 and extends generally parallel to the arm structure 15 and is connected to arm structure 15 for movement therewith. This elongated support member 74 takes the form of an elongated shaft of rod having an upper end 75 located above the upper horizontal chassis member 40 and a lower end 76 located below the lower end 64 of arm structure 15. Support shaft 74 passes through and is journalled in a retainer box 77 which includes internal detent members which prevent vertical (longitudinal) movement of support shaft 74 but, nevertheless, allow rotation of support shaft 74 about it's longitudinal center axis. Retainer box 77 is welded to an L-shaped bracket 78 which is fastened to arm structure attachment plate 61 by a pair of removable, threaded bolts having enlarged finger-grasping heads 79 and 80.

The human leg support assembly 23 is attached to a lower portion of the support member or support shaft 74 just below the lower extremity of retainer box 77. It is welded to support shaft 74 and, if desired, to a lower extension of retainer box 77. The foot rest assembly 20 is connected to the lower end of support shaft 74 by a connector member 81. A hand grip member 82 is attached to the upper end of support shaft 74 for use by the person using the assistance apparatus 10. As seen in FIG. 5, hand grip member 82 may be used to rotate support shaft 74 to swing the leg support assembly 23 and the foot rest assembly 20 to the lateral positions designated as 23aa and 20aa in FIG. 5. The angle φ in FIG. 5 is a ninety degree angle.

As seen in FIG. 9, another hand grip assembly 83 is mounted on chassis 13 and extends upwardly from the upper chassis member 40 on the end thereof farthest removed from the pivot point 65 for the arm structure 15. This hand grip assembly 83 includes a horizontally extending hand grip member 84 for use by a person in the process of sitting down on or arising from the seat 18. As indicated in FIG. 5, hand grip member 84 may be moved through an angle α to extend in a lateral direction relative to chassis 13.

As indicated in FIGS. 9-11, the assistance apparatus 10 further includes a pair of vertically extending chassis support members 85 and 86 for supporting chassis 13. Chassis support 85 is located at the left-hand end of chassis 13 and chassis support 86 is located at the right-hand end of chassis 13. Left support 85 is attached to support legs 27 and 28 and right support 86 is attached to support legs 29 and 30. Left support 85 has a series of vertically spaced peg holes 87 for use in adjusting the vertical height of the left end of chassis 13 relative to the ground or floor level. In a similar manner, right support 86 has a vertically spaced series of peg holes 88 for adjusting the height of the right end of chassis 13. The left and right ends of chassis 13 have peg holes which may be aligned with selected sets of the peg holes 87 and 88. Pegs or pins are inserted into the aligned peg holes to fix the vertical height of chassis 13 relative to the floor. This enables the height of chassis 13 to be adjusted to match the height of the bed 12. As indicated in FIGS. 1-3, it will be generally desirable to have the top of upper horizontal beam 40 slightly below the top level of bed 12. Perhaps more to the point, it is generally desirable to have the top of seat 18 approximately even with the top of bed 12.

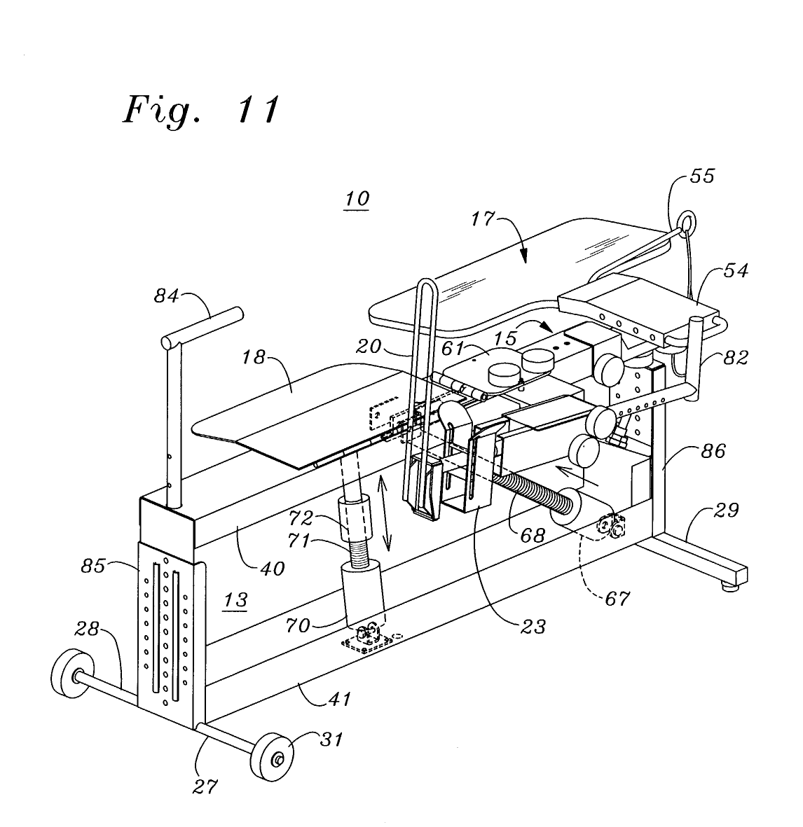

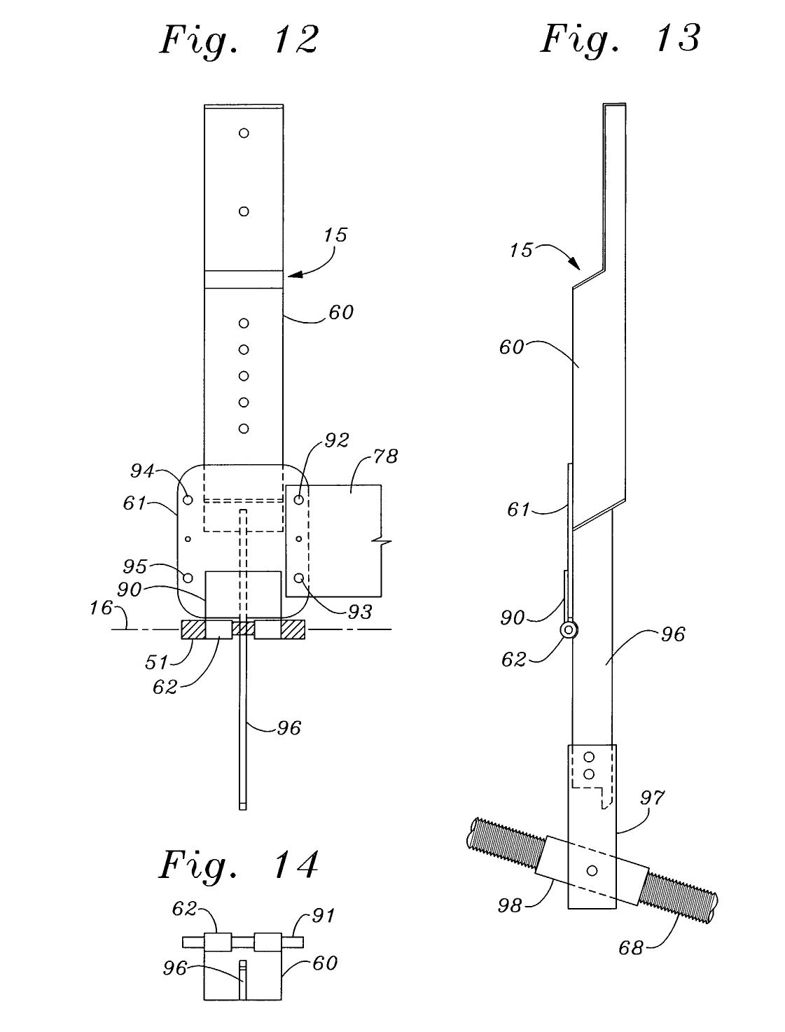

FIG. 12 is an enlarged elevational view taken from the left of the arm structure 15 of FIG. 9. FIG. 13 is a side view of the arm structure 15 of FIG. 12 and FIG. 14 is an end view of the arm structure 15 of FIG. 12. As previously indicated, arm structure 15 includes an elongated arm member 60 having an attachment plate 61 welded on the left facing side thereof. A hinge member 90 is welded to the lower portion of attachment plate 61. Hinge member 90 includes the hinge loops 62 which are used to pivotally connect the arm structure 15 to the chassis 13. The mating hinge loops 51 on chassis 13 are shown in a crosshatched manner in FIG. 12. The connecting hinge pin is indicated at 91 in the end view of FIG. 14. The end of L-shaped connecting bracket 78 is shown in FIG. 12. Bolt holes 92 and 93 are provided for use in bolting bracket 78 to the attachment plate 61. A corresponding set of bolt holes 94 and 95 are provided on the left side of attachment plate 61 for use in repositioning bracket 78 and it's attached support member 74 (FIG. 9) on the opposite side of chassis 13.

As indicated in FIGS. 12-14, the arm structure 15 includes a downwardly extending center arm 96 which is welded to the lower end of arm member 60 and to the back side of attachment plate 61. As indicated in FIG. 13, a coupling bracket 97 is attached to the lower end of center arm 96 and is pivotally connected to a movable nut assembly 98 which rides on and is moved by the lead screw 68 which is connected to the arm structure pivoting motor 67 shown in FIGS. 9-11.

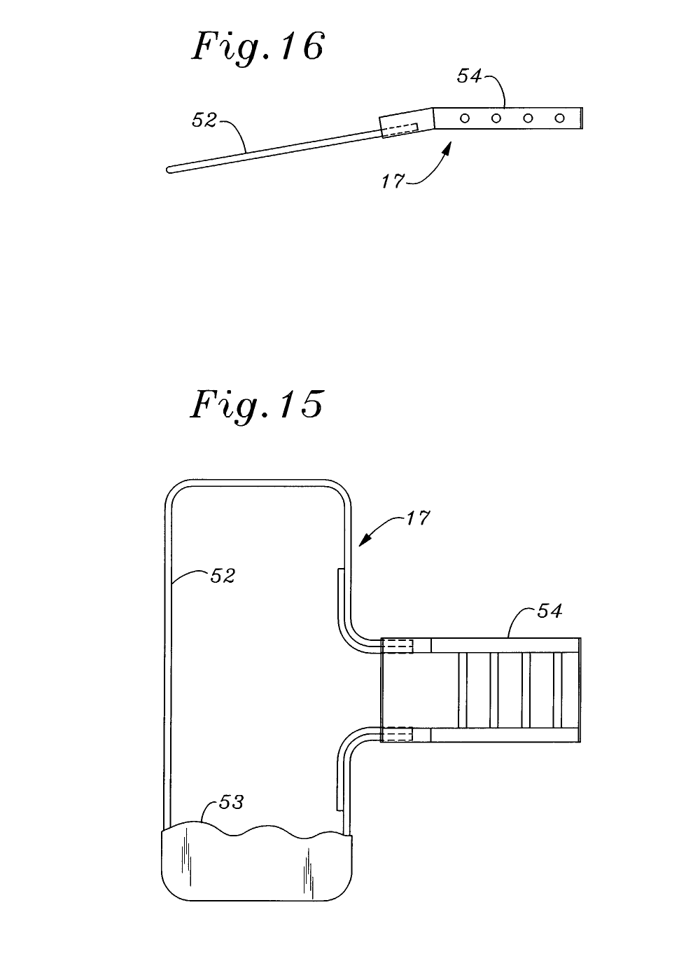

FIG. 15 is an enlarged elevational view of the torso support assembly 17 of FIG. 9. The frame cover 53 has been mostly removed in FIG. 15 to better show the nature of the rectangular metal frame member 52 which provides the primary torso support of the torso support assembly 17. Frame member 52 is attached to the frame mounting assembly 54 which, in turn, is bolted to the upper end of arm structure 15. FIG. 16 is a plan view or top view of the torso support assembly 17 of FIG. 15.

FIG. 17 is a side view of the seat tilting mechanism for the seat 18 of FIG. 9. In FIG. 17, seat 18 is shown in it's maximum tilted position. It's non-tilted or down position is indicated by phantom line construction 18a. The tilt angle γ has a maximum value of approximately fifty degrees. As indicated in FIG. 9, the movable nut assembly 72 is moved up and down by the lead screw 71 which, in turn, is driven by the seat-tilting motor 70. The movable nut assembly 72 has an upwardly-extending arm 100 which extends through the passageway 50 in the chassis top beam 40. The top end of arm 100 is provided with a concave trough 101 which engages a rocker bar 102 which is welded to the under side of seat 18. When the seat-tilting motor 70 is energized for up rotation, arm 100 is urged upward to push the rocker bar 102 and, hence, seat 18 in the upward direction. Conversely, when seat-tilting motor 70 is energized for down rotation, the movable nut assembly 72 moves downward toward it's lowermost position 72a and seat 18 moves toward its down position 18a. FIG. 18 is a back view of the seat-engaging portion of FIG. 17.

While there has been described what is at present considered to be a preferred embodiment of this invention, it will be obvious to those skilled in the art that various changes and modifications may be made therein without departing from the invention and it is, therefore, intended to cover all such changes and modifications as come within the true spirit and scope of the invention.

What is claimed is:

1. Assistance apparatus for assisting a person into and out of bed, such apparatus comprising:
a chassis for positioning beside a bed;
a torso support structure pivotally-mounted on the chassis;
and an actuator mechanism mounted on the chassis and coupled to the torso support structure for causing the torso support structure to pivot from a vertical position to a horizontal position and vice versa.

2. Assistance apparatus in accordance with claim 1 wherein the torso support structure includes:
an arm structure having upper and lower ends and an intermediate point pivotally connected to the chassis;
a torso support assembly attached to the upper portion of the arm structure for supporting the torso of a person using the assistance apparatus;
and the actuator mechanism is coupled to the lower end of the arm structure for causing the arm structure to pivot from a vertical position to a horizontal position and vice versa.

3. Assistance apparatus in accordance with claim 1 wherein the actuator mechanism is a motor-driven lead screw mechanism.

4. Assistance apparatus in accordance with claim 1 and further including:
a control circuit for controlling the actuator mechanism;
and a control switch coupled in circuit with the control circuit and mounted on the torso support structure for activation by a person using the assistance apparatus.

5. Assistance apparatus in accordance with claim 1 and further including:
a human support seat located on an upper portion of the chassis;
and a second actuator mechanism mounted on the chassis and coupled to the human support seat for causing the seat to tilt to an inclined position for assisting a person sitting on the seat to move to a standing position.

6. Assistance apparatus in accordance with claim 5 wherein the second actuator mechanism is a motor-driven lead screw mechanism.

7. Assistance apparatus in accordance with claim 1 and further including a foot rest assembly coupled to the torso support structure for movement therewith.

8. Assistance apparatus for assisting a person into and out of bed, such apparatus comprising:
a chassis for positioning beside a bed and having a horizontally-extending upper chassis member for positioning parallel to the side of the bed near the upper level of the bed;
a human support seat located on the upper chassis member;
an arm structure having upper and lower ends and an intermediate point pivotally connected to the chassis near one side of the seat;
an actuator mechanism mounted on the chassis below the upper chassis member and coupled to the lower end of the arm structure for causing the arm structure to pivot from a vertical position to a horizontal position and vice versa;
and a torso support assembly attached to the upper portion of the arm structure and extending laterally toward the bed for supporting the torso of a person and enabling the person to move from a vertical to a horizontal position as the arm structure pivots from a vertical to a horizontal position and to move from a horizontal position to a vertical position as the arm structure pivots from a horizontal position to a vertical position.

9. Assistance apparatus in accordance with claim 8 wherein the intermediate point on the arm structure is pivotally connected to the upper chassis member near one side of the seat.

10. Assistance apparatus in accordance with claim 8 wherein the actuator mechanism is a motor-driven lead screw mechanism.

11. Assistance apparatus in accordance with claim 8 and further including:
a control circuit for controlling the actuator mechanism;
and a control switch coupled in circuit with the control circuit and coupled to an upper portion of the arm structure for activation by a person using the assistance apparatus.

12. Assistance apparatus in accordance with claim 8 and further including a second actuator mechanism mounted on the chassis below the upper chassis member and coupled to the human support seat for causing the seat to tilt to an inclined position for assisting a person sitting on the seat to move to a standing position.

13. Assistance apparatus in accordance with claim 12 wherein the second actuator mechanism is a motor-driven lead screw mechanism.

14. Assistance apparatus in accordance with claim 12 and further including:
a control circuit for controlling the second actuator mechanism;
and a control switch coupled in circuit with the control circuit and coupled to the upper portion of the arm structure for activation by a person using the apparatus.

15. Assistance apparatus in accordance with claim 8 and further including a human leg support assembly coupled to the arm structure for movement for movement therewith.

16. Assistance apparatus in accordance with claim 8 and further including a foot rest assembly located below the lower end of the arm structure and coupled to the arm structure for movement therewith.

17. Assistance apparatus in accordance with claim 8 and further including a hand grip assembly extending upwardly from the upper chassis member on the side of the seat farthest removed from the arm structure pivot point for use by a person in the process of sitting on the seat.

18. Assistance apparatus in accordance with claim 8 and further including:
an elongated support member coupled to the arm structure and extending generally parallel thereto for movement therewith, such support member having an upper end located above the upper chassis member and a lower end located below the lower end of the arm structure;
and a human leg support assembly attached to a lower portion of the support member for engaging and lifting the leg of a person using the assistance apparatus as the arm structure moves from a vertical position to a horizontal position.

19. Assistance apparatus in accordance with claim 18 and further including a foot rest assembly attached to the lower end of the support member for movement therewith.

20. Assistance apparatus in accordance with claim 18 and further including a hand grip member attached to the upper end of the support member for use by a person using the assistance apparatus.

21. Assistance apparatus for assisting a person into and out of bed, such apparatus comprising:
a chassis for positioning beside a bed and having a horizontally-extending upper chassis member for positioning parallel to the side of the bed near the upper level of the bed;
a human support seat located on the upper chassis member;
an arm structure having upper and lower ends and an intermediate point pivotally connected to the upper chassis member near one side of the seat;
a first actuator mechanism mounted on the chassis below the upper chassis member and coupled to the lower end of the arm structure for causing the arm structure to pivot from a vertical position to a horizontal position and vice versa;
a torso support assembly attached to the upper portion of the arm structure and extending laterally toward the bed for supporting the torso of a person and enabling the person to move from a vertical to a horizontal position as the arm structure pivots from a vertical to a horizontal position and to move from a horizontal position to a vertical position as the arm structure pivots from a horizontal position to a vertical position;
a second actuator mechanism mounted on the chassis below the upper chassis member and coupled to the human support seat for causing the seat to tilt to an inclined position for assisting a person sitting on the seat to move to a standing position;
a first control circuit for controlling the first actuator mechanism;
a second control circuit for controlling the second actuator mechanism;
first and second control switches individually coupled in circuit with respective ones of the first and second control circuits and attached to an upper portion of the arm structure for activation by a person using the assistance apparatus;
a first hand grip assembly extending upwardly from the upper chassis member on the side of the seat farthest removed from the arm structure pivot point for use by a person in the process of sitting on the seat;
an elongated support member coupled to the arm structure and extending generally parallel thereto for movement therewith, such support member having an upper end located above the upper chassis member and a lower end located below the lower end of the arm structure;
a human leg support assembly attached to a lower portion of the support member for engaging and lifting the leg of a person using the assistance apparatus as the arm structure moves from a vertical position to a horizontal position;
a foot rest assembly attached to the lower end of the support member for movement therewith;
and a second hand grip assembly attached to the upper end of the support member for use by a person using the assistance apparatus.
